(19) United States
(12) Patent Application Publication
(10) Pub. No.: US 2012/0223159 A1
(43) Pub. Date: Sep. 6, 2012

(54) Soap Dispenser

(75) Inventor: Keith Alwyn Gregory, Perth (AU)

(73) Assignee: SOAPSTREAM PTY LTD., Perth, Western Australia (AU)

(21) Appl. No.: 13/390,249

(22) PCT Filed: Aug. 11, 2010
(86) PCT No.: PCT/AU2010/001021

§ 371 Date: May 1, 2012

(30) Foreign Application Priority Data
Aug. 11, 2009 (AU) 2009903756

(51) Int. Cl. B05B 7/26; E03C 1/046; A47K 5/08

(52) U.S. Cl. 239/310; 4/628; 137/801

(57) ABSTRACT

The present invention provides a soap dispenser (11) for use with a fluid outlet, such as a tap (15). The soap dispenser (11) comprises a soap holder (213) for holding a soap cartridge. The soap holder comprises at least one upper aperture in an upper region through which fluid enters the soap holder, and at least one lower aperture in a lower region through which fluid exits the soap holder. The soap holder incorporates at least one diverting section (25) to divert any fluid moving in an upward direction back into the holder. The soap dispenser also comprises a connection arrangement for connecting the soap holder with respect to the fluid outlet. In use the soap holder is positioned underneath the fluid outlet such that fluid enters the holder through the at least one upper aperture. The fluid then passes over the soap cartridge and exits through the at least one lower aperture to provide a user with a soapy fluid.

### FIELD OF THE INVENTION

The present invention generally relates to a soap dispenser. In particular the invention relates to a soap dispenser used in combination with a water outlet such as a tap.

### BACKGROUND ART

Traditionally, people use a cake of soap to wash their hands. The soap is usually left next to a basin or trough from where a person will use the soap under the flowing water and place it back in position. This leaves a significant mess, particularly if the person is cleaning their hands after gardening or handling greasy machinery. Furthermore there is a transfer of bacteria from one user to the next. From an occupational health and safety aspect the cake may be dropped, become encrusted with dirt and present a hazard.

A solution to prevent significant soiling of the area around the basin/trough is the use of liquid soap. This is typically dispensed using a pump action container. Whilst this solution does keep the area around the basin cleaner, the liquid soap is prone to leak, particularly in warmer conditions. Furthermore, the dispenser may become blocked, preventing the liquid soap from being dispensed and is easily vandalized and not always in close proximity to the water source.

A further solution is provided by the soap dispenser disclosed in WO 00/41608 to Sudsmaster 2000 Pty Ltd. This document discloses a soap dispenser adapted to receive a soap pellet and which is connected to a tap. The soap dispenser is rotatable between a first position wherein the soap pellet is directly under the water flow, and a second position wherein the soap pellet is clear of the water flow such that the tap may operate in its normal capacity. Whilst this invention solves several disadvantages of the prior art it is prone to splash back from the water flow impacting upon the soap dispenser and soap pellet.

The preceding discussion of the background to the invention is intended only to facilitate an understanding of the present invention. It should be appreciated that the discussion is not an acknowledgment or admission that any of the material referred to was part of the common general knowledge as at the priority date of the application.

### SUMMARY OF INVENTION

It is an object of this invention to provide a soap dispenser which ameliorates, mitigates or overcomes, at least one disadvantage of the prior art, or which will at least provide the public with a practical choice.

The invention has also been developed to encourage people to wash their hands and to maintain good hand hygiene. By providing a soap dispenser which addresses the deficiencies of the prior art people will more readily have access to a soapy solution without creating excessive mess.

The present invention provides a soap dispenser for use with a fluid outlet, such as a tap, the soap dispenser comprises:
a soap holder for holding a soap cartridge, the soap holder comprising at least one upper aperture in an upper region through which fluid enters the soap holder, and at least one lower aperture in a lower region through which fluid exits the soap holder;
the soap holder incorporating at least one diverting section to divert any fluid moving in an upward direction back into the holder; and
a connection arrangement for connecting the soap holder with respect to the fluid outlet;
   wherein the soap holder is positioned underneath the fluid outlet such that fluid enters the holder through the at least one upper aperture, the fluid then passes over the soap cartridge and exits through the at least one lower aperture to provide a user with a soapy fluid.

Preferably the diverting section is incorporated in the upper section.

Preferably the diverting section is curved. The diverting section may have a square profile or may be ‘U’ shaped such that the fluid which is diverted upwardly is caused to move downwardly relatively to the soap holder.

With similar prior art the fluid is diverted into multiple directions upon impact with the soap cartridge. This creates significant mess. The present soap dispenser aims to minimise the amount of splashback by containing and redirecting fluid which, upon impact with the soap cartridge, diverts away from its original flow direction. Fluid which impacts upon the soap cartridge is first contained within the soap holder. Any fluid that is diverted upwardly flows into the upper region whereupon it is diverted towards the lower region of the soap dispenser by the curved section. Thus minimising the amount of fluid splashing from the soap dispenser during use.

Preferably the soap holder is configured to maintain the soap cartridge in a central position such that the soap cartridge does not engage the inside wall of the soap holder. This provides a passage for the fluid flow and minimises splash back which would occur if the soap cartridge was in engagement with the inner wall.

The soap holder may have a plurality of ribs projecting inwardly from an inside wall. The ribs act to maintain a gap between the soap cartridge and the inside wall around the entire soap cartridge, thus maintaining the passage for the fluid to flow through.

The lower region of the soap holder may have a plurality of apertures incorporated in the lower end wall of the soap holder and/or the side wall of the soap holder. The apertures may be in the form of slots. The end wall may be of suitable thickness such that each aperture provides a passageway whereby fluid flow direction straightens as it passes therethrough. Thus, as the fluid exits the soap holder, the fluid moves in a relatively straight manner, minimising any splashback which may occur as the fluid exits the soap holder.

Preferably the apertures are curved relative to their perpendicular axis so as to create a hydrofoil effect upon the fluid flow. Again this is to minimise any splashback which may occur as the fluid exits the soap holder.

The soap holder may comprise a container and a closure, wherein the closure is releasably retained relative to the container.

The closure may define the upper region and incorporate the curved section therein.

In one aspect of the invention the closure may be rotatable relative to the container between a first position, wherein the closure is attached to the container, and a second position wherein the body may receive the soap cartridge.

In another aspect of the invention the closure may be located above and adjacent to the container when the closure is in the first position.

In yet another aspect of the invention the closure is clipped onto the container. The closure may be removed for cleaning purposes. The at least one upper aperture may be provided by the closure and may be of sufficient size to allow the soap cartridge to pass therethrough.

The closure may receive a removable grate which extends over the at least one upper aperture. The grate will assist with minimising vandalism.

The closure may comprise one or more weep holes through which a small portion of the fluid may exit the soap holder. Each weep hole may comprise a cover external of the closure. The weep hole will allow soapy fluid to exit the soap holder and pass down an outer face of the soap holder. This assists in keeping the soap holder clean and thus reducing the transfer of bacteria between users.

The soap holder may also receive a basket therein. The basket may be adapted to support the soap cartridge. In some applications the soap cartridge will be of a consistency whereby the cartridge is quite soft once wet. The basket is then required to support the soap cartridge and allow the free flow of fluid. With this arrangement an operator may place a new soap cartridge in the soap holder and with minimal force cause any amount of the old cartridge to be expelled through the lower region of the basket.

Preferably the basket is removable to allow for easy cleaning and replacement.

The basket may have slots therein for receiving the ribs. Alternatively, the basket may be shaped to accommodate the ribs to fit therebetween. In a further alternative the ribs are incorporated in the basket.

The soap dispenser may have a flow diverter located at or adjacent the at least one upper aperture. The flow diverter diverts the fluid as it enters the soap holder so as to further minimise splashback. With the flow diverter the fluid does not impact directly upon the soap cartridge but is rather directed towards the passages between the soap cartridge and the inner wall of the soap holder. This is particularly relevant when a new soap cartridge is placed therein.

The flow diverter may be conical in shape.

The flow diverter may be integral with the soap cartridge.

The lower end wall of the soap holder may have a projection extending upwardly therefrom, wherein the soap cartridge may be positioned thereupon to ensure a gap is maintained between the soap cartridge and the apertures in the lower end wall.

Preferably the soap holder is movable from a first position wherein the at least one upper aperture of the soap holder aligns with the fluid outlet such that the fluid enters the soap holder, and a second position wherein the fluid outlet does not enter the soap holder. In the second position the soap cartridge may be placed in the soap holder.

In one aspect the soap holder may be manually moved between the first position and second position.

In another aspect the soap holder may move automatically between the first position and second position. The soap holder may move into the first position upon operation of the fluid outlet and may automatically return to its second position after a predetermined period of time.

The fluid outlet may be in the form of a tap/faucet assembly. For the purpose of convenience, the term tap will be used to describe the fluid outlet. This is understood to also include faucets and other terms used to describe a tap assembly.

The connection arrangement may comprise a body which is adapted to be secured to the tap.

The body may be retained relative to the tap.

The body may be an integral part of the tap.

The body may be threadingly secured to a portion of the tap at a position along the tap arm, or directly to an end of the tap from which the fluid is discharged. In one aspect of the invention the soap holder is rotatable between the first position and second position.

The body may be received upon and rotate relative to a spindle upon which the tap is mounted. In this arrangement the body is typically co-axially mounted with respect to the tap arm and is able to move between the first position and second position in a similar manner to the actual tap.

The soap holder may rotate about a spigot which may be housed in the body of the connection arrangement.

In another aspect of the invention the soap holder slides relative to the fluid outlet to move between the first position and second position.

The fluid outlet may have a guide rail fixed relatively thereto upon which the connection arrangement of the soap holder matingly engages for sliding movement therealong. The guide rail may be integral with the tap or may be secured separately thereto.

The soap dispenser may comprise a retaining means to prevent the soap dispenser detaching from the guide rail. The body of the connection arrangement may have a slot which receives the guide rail.

In another aspect of the invention the soap holder is able to slide and rotate relative to the fluid outlet to move between the first position and second position.

The soap dispenser may incorporate a retaining means to retain the soap holder in position. The retaining means may be in the form of a detent assembly.

The soap holder may be movable between more than two positions.

The present invention further provides a soap dispenser for use with a fluid outlet, such as a tap, the soap dispenser comprises:
a soap holder for receiving a soap cartridge, the soap holder comprising at least one lower aperture in a lower region and at least one upper aperture in an upper region;
connection arrangement for connecting the soap holder to the fluid outlet, the connection arrangement being in the form of a body which is adapted to be slidingly received on a guide rail secured relative to the fluid outlet;
   wherein the soap holder is slidingly movable from a first position wherein the at least one upper aperture of the soap holder aligns with the fluid outlet such that the fluid enters the soap holder, and a second position wherein the fluid outlet does not enter the soap holder.

The present invention further provides a soap dispenser for use with a fluid outlet provided by a tap, the soap dispenser comprises:
a soap holder for receiving a soap cartridge, the soap holder comprising at least one lower aperture in a lower region and at least one upper aperture in an upper region;
connection arrangement for connecting the soap holder to the fluid outlet, the connection arrangement being in the form of a body coaxially mounted with respect to an arm of the tap;
   wherein the soap holder is rotatably movable from a first position wherein the at least one upper aperture of the soap holder aligns with the fluid outlet such that the fluid enters the soap holder, and a second position wherein the fluid outlet does not enter the soap holder.

The present invention further provides a soap dispenser as above described and further comprising a tap.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

The invention will be better understood by reference to the following description of several specific embodiments thereof as shown in the accompanying drawings in which:

FIG. 1 a, b, c, d show a plan, front, side and cross sectional side view of a soap dispenser according to a first embodiment;

FIG. 2 a, b, c, d show a plan, front, side and cross sectional side view of a soap dispenser according to a second embodiment;

FIG. 3 a, b, c, d show a plan, front, side and cross sectional side view of a soap dispenser according to a third embodiment, whereby the soap dispenser is connected to a tap;

FIG. 4 a, b, c, d show a plan, front, side and cross sectional side view of a soap dispenser according to a fourth embodiment, whereby the soap dispenser is connected to a tap;

FIG. 5 is a cross sectional side view of a fifth embodiment with a soap dispenser in a first position;

FIG. 6 is a view similar to FIG. 5 having the soap dispenser in a second position;

FIG. 7 is a perspective view of FIG. 6;

FIG. 8 is a view similar to FIG. 5 ready to receive a soap cartridge;

FIG. 9 is a perspective view of a soap dispenser according to a sixth embodiment in a first position;

FIG. 10 is similar to FIG. 9 but with the soap dispenser in a second position;

FIG. 11 is a cross sectional perspective side view of a connection arrangement and a soap holder of the soap dispenser shown in FIG. 9;

FIG. 12 is a cross sectional perspective side view of a body of the connection arrangement and a basket of the soap holder shown in FIG. 11;

FIG. 13 is a cross sectional side view of FIG. 12 with a closure secured to the soap holder;

FIG. 14 is a perspective view of the basket and closure shown in FIG. 13 with a grate across the closure;

FIG. 15 is similar to FIG. 14 but without the grate; and

FIG. 16 is perspective view of the basket shown in FIG. 12.

### BEST MODE(S) FOR CARRYING OUT THE INVENTION

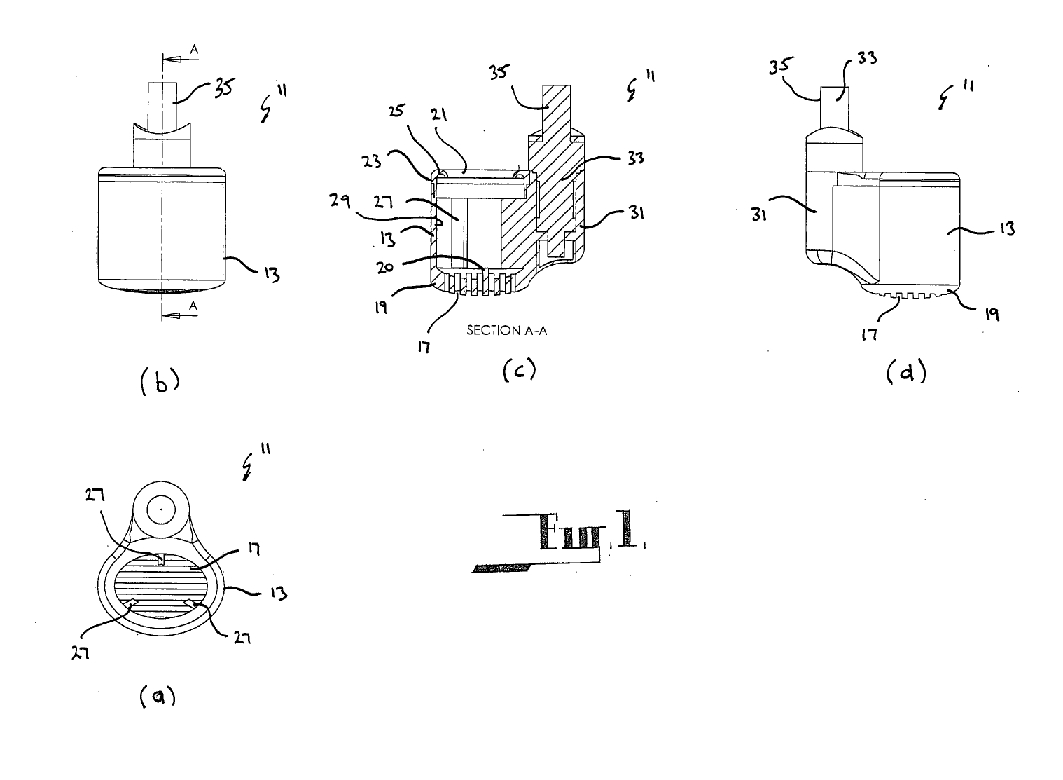

Referring to FIGS. 1 a, b, c, d the invention according to the first embodiment is in the form of a soap dispenser 11 secured to a fluid outlet, such as a tap 15 for discharging water (the tap is not shown in the figures of the current embodiment). The soap dispenser 11 is adapted to hold a soap cartridge (not shown). When water flows from the tap 15 the water passes into the soap dispenser 11, passing over the soap cartridge. By the time the water passes through and emerges from the soap dispenser 11 the water has mixed sufficiently with the soap cartridge to provide a user of the tap 15 with a soapy solution such that they may wash their hands or other object.

The soap dispenser 11 comprises a soap holder 13 which receives a soap cartridge (not shown).

The soap holder 13 comprises a plurality of lower apertures, in the form of slots 17 located in its lower end wall 19. The slots 17 provide a passage for the water to exit the soap dispenser 11. As best seen in FIG. 1c, the lower end wall 19 is of suitable thickness such that each slot 17 defines a passageway. The passageway is designed to provide a relatively uniform fluid flow as the water exits the soap holder 17. This minimises splashing of the water as it exits the soap dispenser 11.

The lower end wall 19 also has a projection 20 extending inwardly. In use the soap cartridge engages the projection 20 to ensure a gap is maintained between the bottom of the soap cartridge and slots 17 to ensure there is a clear passage between the soap cartridge and soap holder 13.

The soap holder 13 also comprises an upper aperture 21 located in the upper region 23 of the soap holder 13. When the soap holder 13 is below the tap 15, the water exiting the tap 15 passes through the upper aperture 21 into the soap holder 13.

The upper aperture 21 is of sufficient size to allow the soap cartridge to pass therethrough into the soap holder 13.

As best shown in FIG. 1c the upper region 21 comprises a diverting section in the form of a curved section 25. The curve section 25 is shaped and acts to divert any flow moving in an upward direction back into the soap holder 13. In use, as water impacts upon the soap cartridge a portion of the water is deflected to engage the side wall of the soap holder 13. In turn a portion of this water is deflected in an upward direction. Upon reaching the curved section 25 this water is diverted back down towards the lower region of the soap holder 13 rather than splashing out of the soap holder 13.

The soap holder 13 also has three ribs 27 extending from an inner wall 29 of the soap holder 13, as best shown in FIGS. 1a and 1c. The ribs 27 are in spaced relation. In operation the ribs 27 engage the soap cartridge to maintain a gap between the periphery of the soap cartridge and inner wall 29. This ensures there is a continuous passage surrounding the soap cartridge for the water to flow through whilst in contact with the soap cartridge.

The soap dispenser 11 also comprises a connection arrangement for connecting the soap holder 13 to the tap 15. The connection arrangement comprises a body 31 secured to the soap holder 13, and a spigot 33.

The spigot 33 has a first end 35 which is threadingly received in the tap 15 so as to secure the soap dispenser 11 in place.

The spigot 33 is rotatably housed within the body 31 such that the soap holder 13 is rotatably movable from a first position wherein the upper aperture 21 of the soap holder 13 aligns with the fluid outlet of the tap, and a second position wherein the fluid outlet does not enter the soap holder 13. In use the soap holder 13 may be placed in its first position whereby a user will be able to wash with soapy water. Should the user then wish to simply rinse, the soap holder 13 may be moved to the second position to provide a free stream of water.

The soap dispenser 11 uses a soap cartridge which dissolves overtime and will require replacing. To insert a new soap cartridge the soap holder 13 is placed in the second position and the cartridge is inserted through the upper aperture 21.

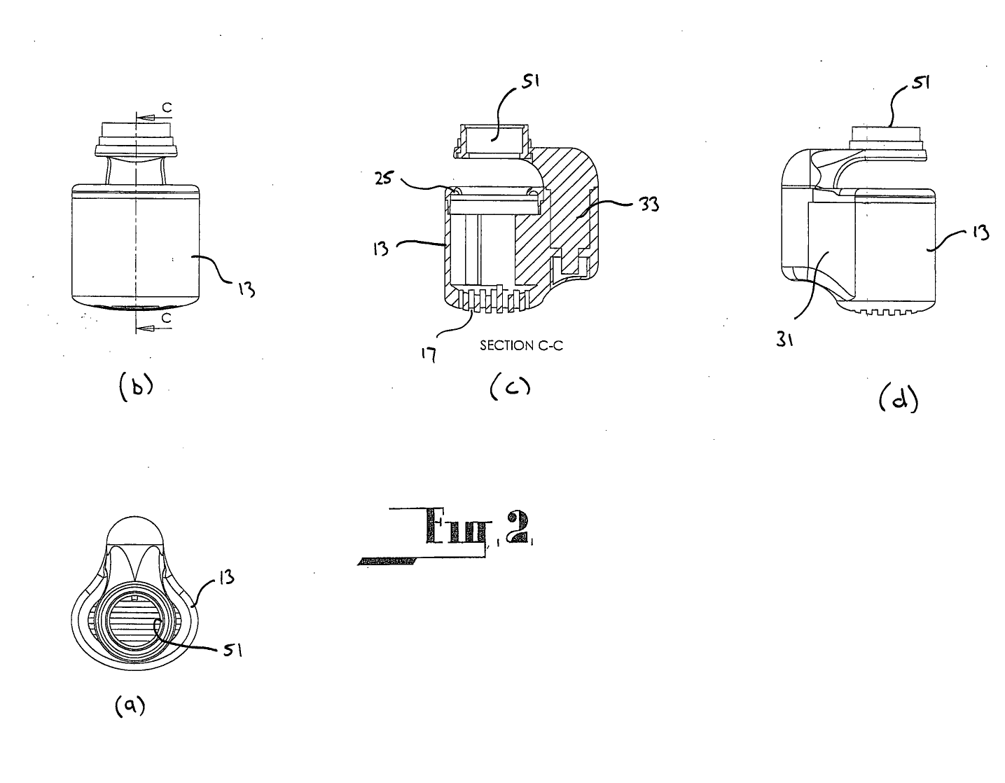

A second embodiment of the invention is illustrated in FIGS. 2 a, b, c, d. For convenience features of the soap dispenser 11 that are similar or correspond to features of the soap dispenser 11 of the first embodiment have been referenced with the same reference numerals.

This embodiment has an alternative connection arrangement to that of the first embodiment. In this embodiment the body 31 of the connection arrangement has a threaded opening 51 adapted to threadingly engage a threaded end portion of a tap. In this embodiment the fluid flows through the tap 15, passes through threaded opening 51 before flowing into the soap holder 13. Once connected, the connection arrangement does not significantly inhibit the fluid flowing from the tap 15.

A third embodiment of the invention is illustrated in FIGS. 3 a, b, c, d. For convenience features of the soap dispenser 11 that are similar or correspond to features of the soap dispenser 11 of the previous embodiments have been referenced with the same reference numerals.

This embodiment has an alternative connection arrangement to the first and second embodiments whereby the body 31 of the connection arrangement slidingly engages the tap 15. In this embodiment a guide rail 61 is formed integral with the tap 15. The body 31 has an upper portion having a cross sectional slot 63 of complementary shape to that of the guide rail 61. With this arrangement the soap dispenser 11 is retained relative to the tap such that it may slide between the first position and second position.

The soap dispenser 11 also comprises a retaining means 65 to prevent the soap dispenser 11 detaching from the tap as it slides therealong. The retaining means 65 comprises a projection 67 which is biased upwardly from the body 31. The guide rail 61 also has a projection 69 upon which the projection 67 of the soap dispenser 11 abuts to define the forward most position of the soap dispenser 11, preventing continued movement therealong, as best shown in FIG. 3c.

The retaining means 65 also has a lever 71 to retract the projection 67 of the soap dispenser 11 into the body 31. When retracted the soap dispenser 11 is able to be separated from the tap 15. This may be required in certain circumstances, such as to replace the soap dispenser 11.

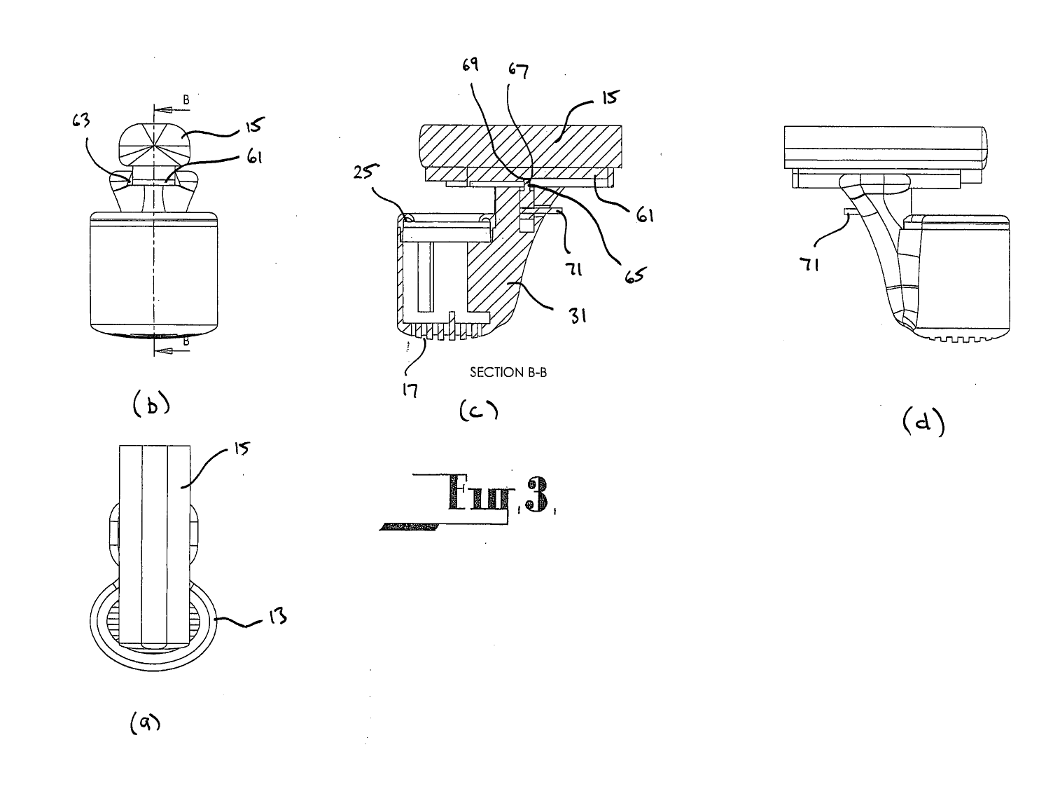

A fourth embodiment of the invention is illustrated in FIGS. 4 a, b, c, d. For convenience features of the soap dispenser 11 that are similar or correspond to features of the soap dispenser 11 of the previous embodiments have been referenced with the same reference numerals.

This embodiment combines the third embodiment with similar features to that described in the first and second embodiment. In so doing the fourth embodiment takes the soap dispenser 11 of the third embodiment and incorporates a spigot 133 within the body 31. As a result the soap dispenser 11 is slidable relative to the water outlet of the tap 15, as well as being rotatable about the spigot 133. This would assist with the replacement of the soap cartridge.

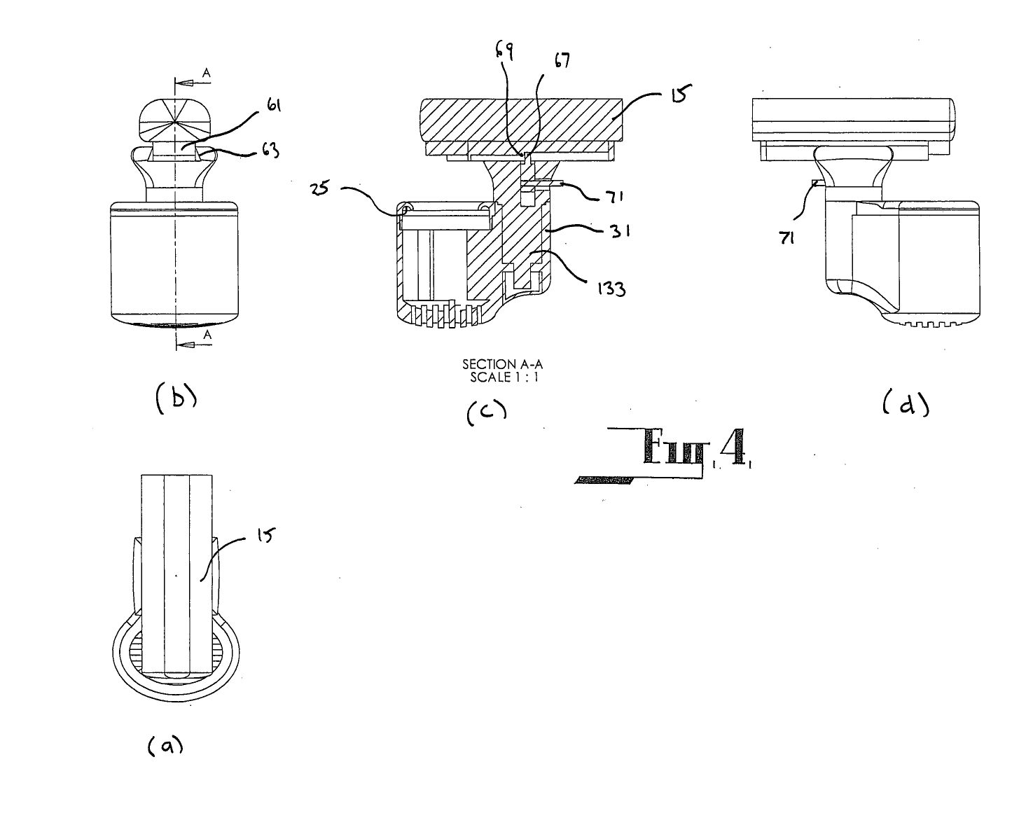

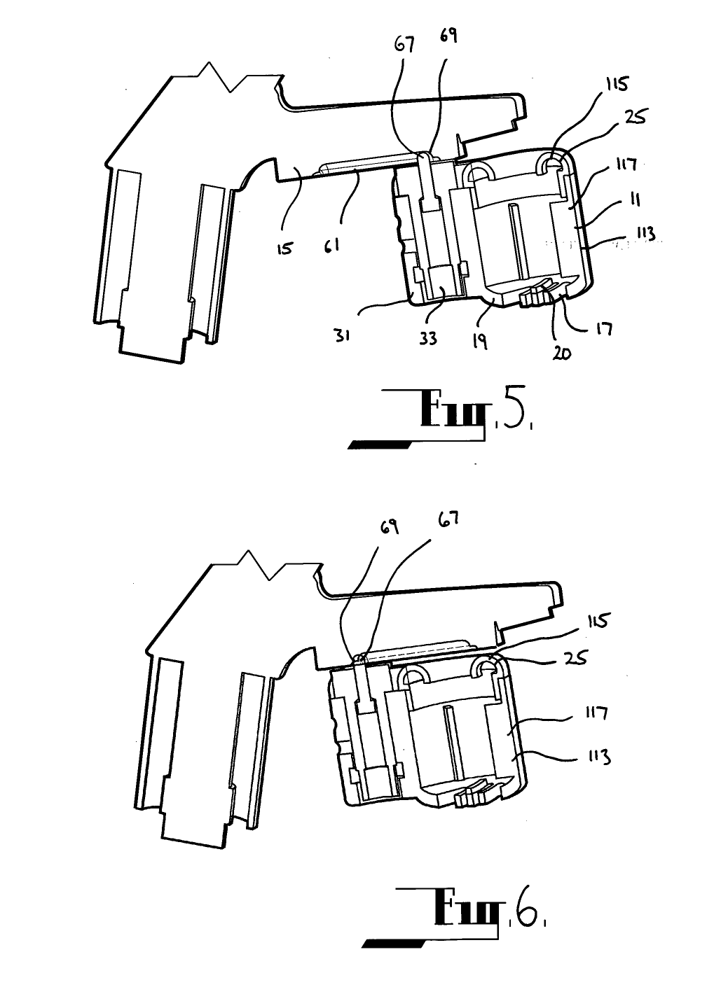

A fifth embodiment is illustrated in FIGS. 5 to 8. For convenience features of the soap dispenser 11 that are similar or correspond to features of the soap dispenser 11 of the previous embodiments have been referenced with the same reference numerals.

This embodiment is similar to that described in the third embodiment. The differing feature relates to the soap holder 113 which, in this embodiment, is of two part construction, a closure 115 and a container 117.

The container 117 is adapted to receive and support the soap cartridge.

The closure 117 defines an upper region and incorporates the curved section 25 and upper aperture 21. The closure 117 is separable from the container 117 to allow a new soap cartridge to be placed within the container. This feature allows the upper aperture 21 to be smaller in size than the soap cartridge. The smaller opening minimises the amount of water which may escape from the upper region of the soap holder and therefore minimises splashback.

As best shown in FIG. 8, the container 117 may be moved downwardly, to disengage from the closure 115. This will allow the closure 115 and/or container 117 to be rotated relative to each other as well as the water outlet, thus providing access to the container 117 for replacement of the soap cartridge.

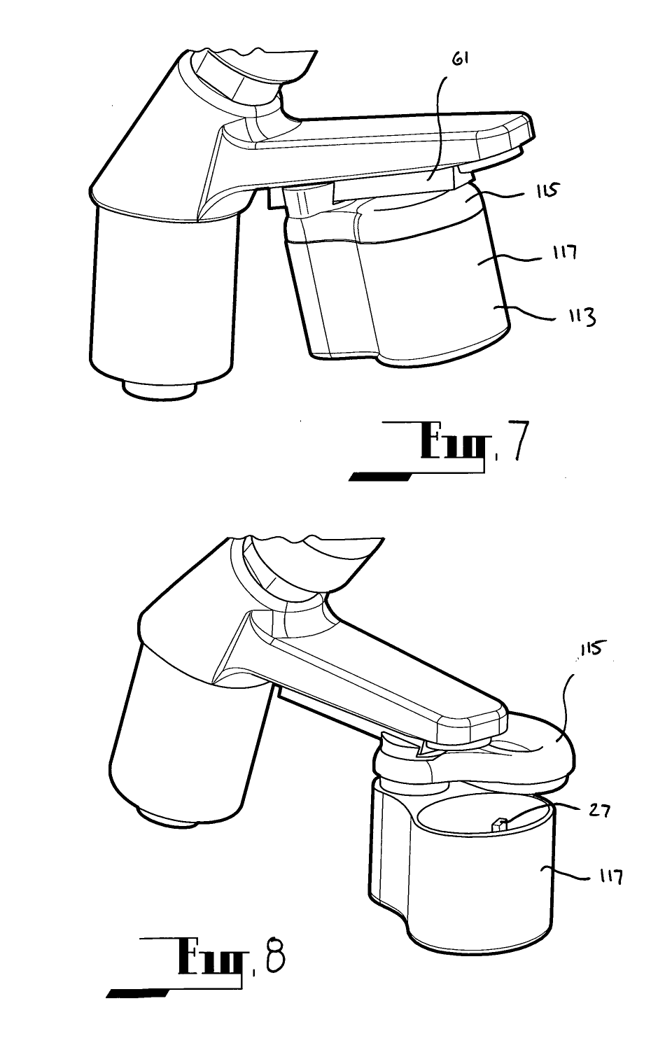

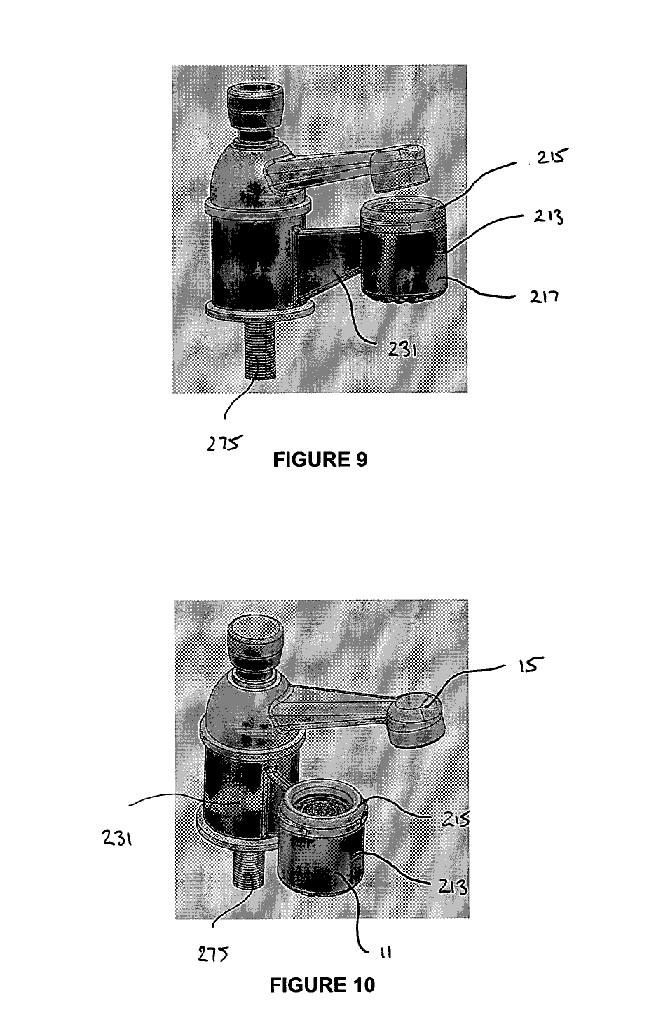

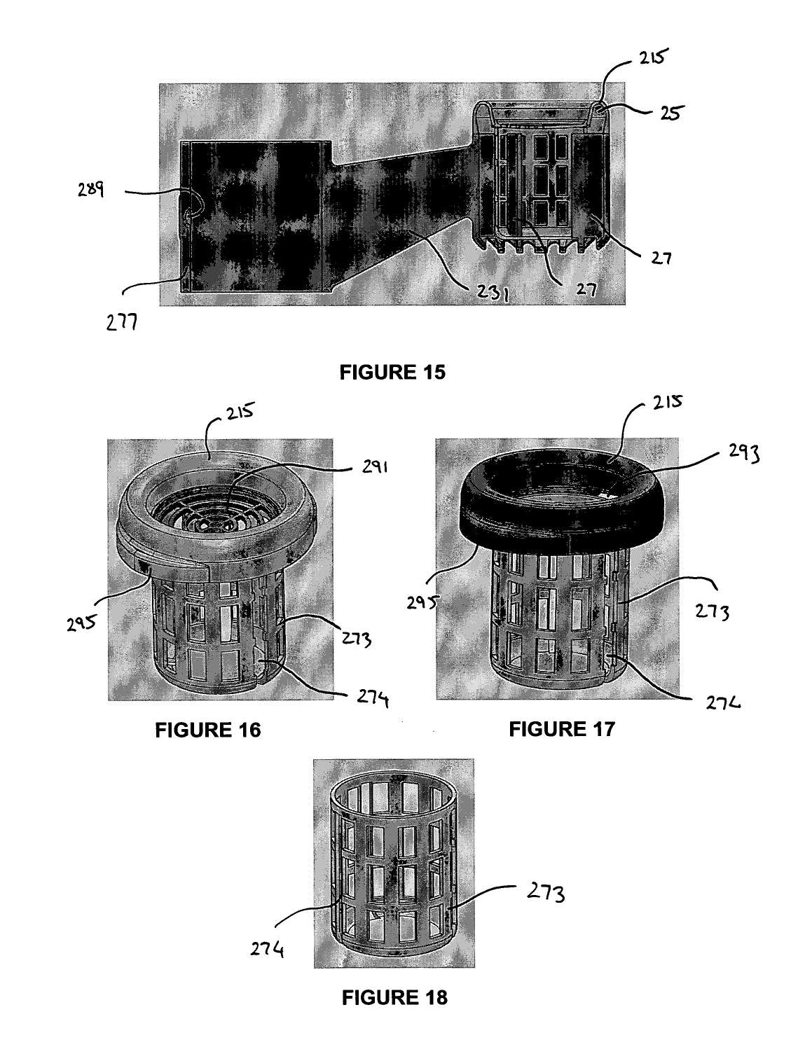

A sixth embodiment is illustrated in FIGS. 9 to 18. For convenience features of the soap dispenser 11 that are similar or correspond to features of the soap dispenser 11 of the previous embodiments have been referenced with the same reference numerals.

This embodiment is similar to that described in the previous embodiments. The differing features relate to the connection arrangement, whereby the soap holder 213 is not directly secured to the tap 15, the closure 215, and the incorporation of a basket 273.

The connection arrangement of the present embodiment comprises a body 231 secured to the soap holder 213. The body 231 is adapted to be received on a spindle 275 whereby the spindle 275 also has the tap 15 mounted thereon. In this arrangement the body 231 and tap are co-axially mounted in a manner whereby they both rotate independent to each other about the spindle 275.

The soap holder 213 is secured to a first end of the body 231. The second end of the body 231 provides a sleeve 277 which is adapted to be rotatably received over a cylindrical mount 279. The cylindrical mount 279 is adapted to be secured with respect to the spindle 275. The cylindrical support 279 supports two ‘O’ rings 281 spaced at either end thereof. The ‘O’ rings 279 minimise the non-rotational movement between the sleeve 277 and cylindrical mount 279. Also, the ‘O’ rings 279 provide friction between the sleeve 277 and cylindrical mount 279 to assist in retaining the soap dispenser 11 in the required position.

The soap dispenser 11 also incorporates a retaining means 265 to releasably retain the soap holder 213 in the first or second position. The retaining means 265 is in the form of a detent assembly 283.

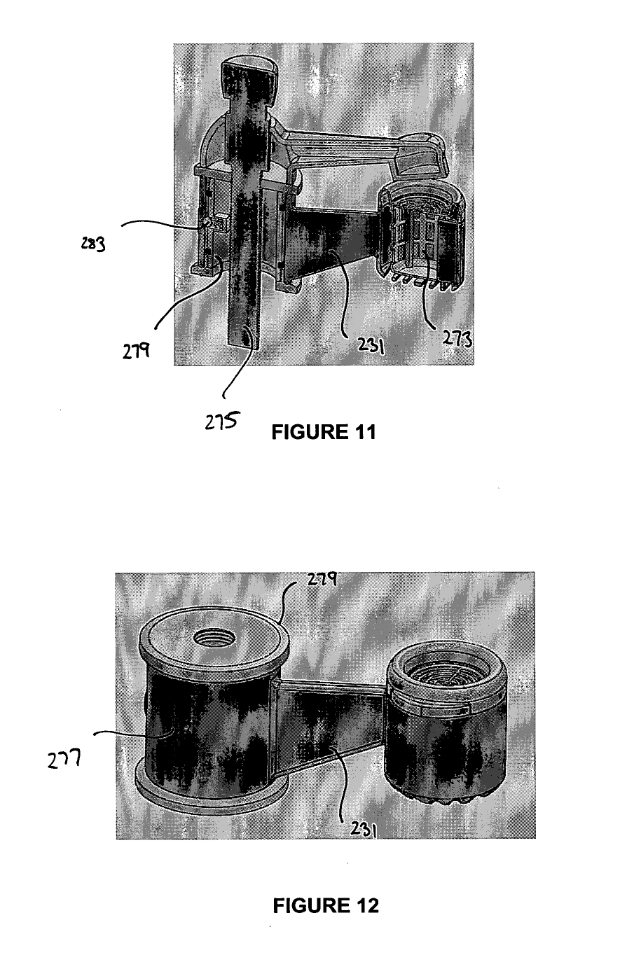

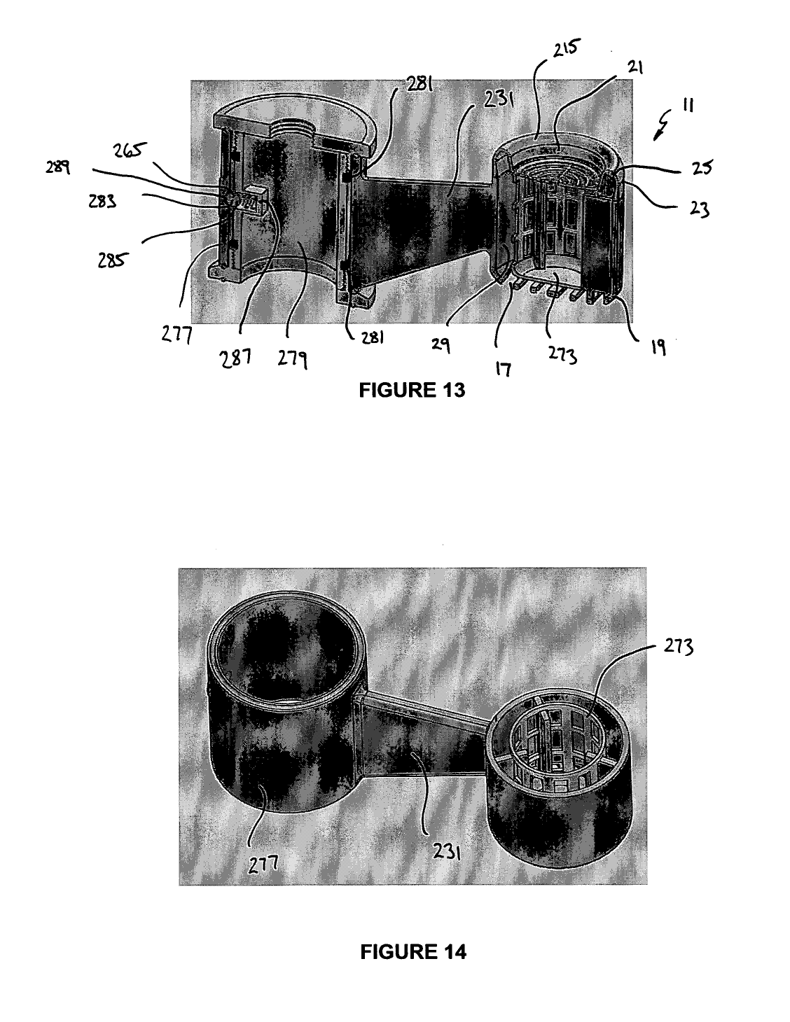

As best shown in FIGS. 11 and 13, the detent assembly 283 comprises a ball bearing 285 supported by, and biased outwardly from a recess 287 formed in the cylindrical mount 279.

The detent assembly 283 also comprises two circular depressions 289 (only one shown) which are formed to receive the ball bearing 285. The depressions 289 are positioned such that the soap dispenser 11 is in the first position when the ball bearing is received in one depression 289a, and is in the second position when the ball bearing is in the second depression 289b.

In the current embodiment the soap holder 213 comprises a closure 215 which is removably received on a container 217. The closure 215 provides the upper region of the soap holder 213 and has the diverting section in the form of a curved section 25 incorporated therein.

The closure 215 is also adapted to support a removable grate 291. The grate 291 is formed to allow water to flow into the soap dispenser 11 whilst minimising splashback. Furthermore, the grate 291 prevents objects being placed into the soap dispenser which may render the soap dispenser 11 inoperable.

The closure also incorporates two weep holes 293 in the side thereof. The weep holes 293 allow water to be diverted from the soap holder 213. Each weep hole 293 is associated with a cover 295 such that water diverted through the weep hole 293 is caused to run down an outer face of the soap holder 213. This assists in keeping the soap dispenser 11 clean.

In this embodiment the soap holder 213 is also adapted to receive a basket 273. A particular soap cartridge which may be used with the soap dispenser 11 is designed to significantly soften when mixed with water. This ensures that the water leaving the water dispenser 11 is sufficiently soapy even with a very short burst of water passing through the soap dispenser 11. In order to support this form of soap cartridge the basket 273 is placed in the soap holder 213 and the soap cartridge placed therein. The basket 273 assists in keeping the soap cartridge in a central region of the soap holder 213.

In use it is expected that once the soap cartridge is nearly depleted a new soap cartridge may be inserted in the soap holder 213. As the depleted soap cartridge is quite soft it can easily be forced out of the basket 273 such that the new one can be received therein. Hence, it is not necessary to wait until the old soap cartridge is completely depleted, nor is it necessary to remove the partially depleted soap cartridge in order to install a new soap cartridge.

As noted particularly in FIGS. 12 and 18, the basket 273 has a series of slots 274 incorporated therein for accommodating the ribs 27 extending inwardly from the inner wall 29 of the soap holder 213.

With the present invention there is no need for a user to use a cake of soap or liquid soap. The user simply needs to turn the tap on and wash his/her hands. If the user does not require a soapy solution the present invention also allows the user to move the soap dispenser to a second position such that they are able to use normal water. The soap dispenser of the present invention is also configured to minimise any splashback which would otherwise occur when the water impact upon the water cartridge.

The present invention is also expected to improve hand hygiene as a soap solution will be more readily available then prior art solutions.

Reference to positional descriptions, such as lower and upper, are to be taken in context of the embodiments depicted in the figures, and are not to be taken as limiting the invention to the literal interpretation of the term but rather as would be understood by the skilled addressee.

Modifications, combinations and variations such as would be apparent to the skilled addressee are considered to fall within the scope of the present invention. Throughout the specification, unless the context requires otherwise, the word “comprise” or variations such as “comprises” or “comprising”, will be understood to imply the inclusion of a stated integer or group of integers but not the exclusion of any other integer or group of integers.

1. A soap dispenser for use with a fluid outlet, such as a tap, the soap dispenser comprises:
a soap holder for holding a soap cartridge, the soap holder comprising at least one upper aperture in an upper region through which fluid enters the soap holder, and at least one lower aperture in a lower region through which fluid exits the soap holder;
the soap holder incorporating at least one diverting section to divert any fluid moving in an upward direction back into the holder; and
a connection arrangement for connecting the soap holder with respect to the fluid outlet;
wherein the soap holder is positioned underneath the fluid outlet such that fluid enters the holder through the at least one upper aperture, the fluid then passes over the soap cartridge and exits through the at least one lower aperture to provide a user with a soapy fluid.

2. The soap dispenser according to claim 1 wherein the diverting section is incorporated in the upper section.

3. The soap dispenser according to claim 1 wherein the diverting section is curved.

4. (canceled)

5. The soap dispenser according to claim 1 wherein the soap holder has a plurality of ribs projecting inwardly from an inside wall.

6. The soap dispenser according to claim 1 wherein the lower region of the soap holder has a plurality of apertures incorporated in a lower end wall of the soap holder and/or the side wall of the soap holder.

7. (canceled)

8. The soap dispenser according to claim 1 wherein the soap holder comprises a container and a closure, wherein the closure is releasably retained relative to the container.

9. The soap dispenser according to claim 8 wherein the closure defines the upper region and incorporates the curved section therein.

10. The soap dispenser according to claim 8 wherein the closure is rotatable relative to the container between a first position, wherein the closure is attached to the container, and a second position wherein the body may receive the soap cartridge.

11. The soap dispenser according to claim 8 wherein the closure is clipped onto the container and is removable for cleaning purposes.

12. (canceled)

13. The soap dispenser according to claim 8 wherein the closure receives a removable grate which extends over the at least one upper aperture.

14. The soap dispenser according to claim 8 wherein the closure comprise one or more weep holes through which a small portion of the fluid may exit the soap holder.

15. The soap dispenser according to claim 14 wherein each weep hole comprises a cover external of the closure.

16. The soap dispenser according to claim 1 wherein the soap holder removably receives a basket therein, the basket being adapted to support the soap cartridge.

17. (canceled)

18. The soap dispenser according to claim 16 wherein the basket is shaped to accommodate the ribs to fit therebetween.

19. The soap dispenser according to claim 16 wherein the ribs are incorporated in the basket.

20.-21. (canceled)

22. The soap dispenser according to claim 1 wherein the soap holder is movable between a first position wherein the at least one upper aperture of the soap holder aligns with the fluid outlet such that the fluid enters the soap holder, and a second position wherein the fluid outlet does not enter the soap holder.

23.-27. (canceled)

28. The soap dispenser according to claim 22 wherein the soap holder is rotatable between the first position and second position, the body received upon and rotates relative to a spindle upon which the tap is mounted so as to be co-axially mounted therewith.

29.-36. (canceled)

37. A soap dispenser for use with a fluid outlet, such as a tap, the soap dispenser comprises:
a soap holder for receiving a soap cartridge, the soap holder comprising at least one lower aperture in a lower region and at least one upper aperture in an upper region;
connection arrangement for connecting the soap holder to the fluid outlet, the connection arrangement being in the form of a body which is adapted to be slidingly received on a guide rail secured relative to the fluid outlet;
wherein the soap holder is slidingly movable from a first position wherein the at least one upper aperture of the soap holder aligns with the fluid outlet such that the fluid enters the soap holder, and a second position wherein the fluid outlet does not enter the soap holder.

38. A soap dispenser for use with a fluid outlet provided by a tap, the soap dispenser comprises:
a soap holder for receiving a soap cartridge, the soap holder comprising at least one lower aperture in a lower region and at least one upper aperture in an upper region;
connection arrangement for connecting the soap holder to the fluid outlet, the connection arrangement being in the form of a body coaxially mounted with respect to an arm of the tap;
wherein the soap holder is rotatably movable from a first position wherein the at least one upper aperture of the soap holder aligns with the fluid outlet such that the fluid enters the soap holder, and a second position wherein the fluid outlet does not enter the soap holder.

39. A tap comprising a soap dispenser according to claim 1.

40. (canceled)
